(19) United States
(12) Patent Application Publication
(10) Pub. No.: US 2024/0183370 A1
(43) Pub. Date: Jun. 6, 2024

(54) Captured Fastener for Thin Components

(71) Applicant: Illinois Tool Works Inc., Glenview, IL (US)

(72) Inventor: Chad M. Clark, Stamping Ground, KY (US)

(21) Appl. No.: 18/521,154

(22) Filed: Nov. 28, 2023

Related U.S. Application Data
(60) Provisional application No. 63/429,584, filed on Dec. 2, 2022.

(51) Int. Cl. F16B 5/02; F16B 43/00

(52) U.S. Cl. CPC F16B 5/02; F16B 43/00

(57) ABSTRACT

Disclosed is a retainer assembly to securely couple a fastener to a component, the retainer assembly having a sleeve and a retainer. The sleeve includes a tube, a first flange, a second flange and a collar. The sleeve defines a central passage having a central longitudinal axis. The first flange and the second flange are separated by a tube. The collar includes one or more external ribbed features formed in or on an exterior surface of the collar and configured to press into and retain in the component. The collar is configured to reside within the opening and to provide compression limiting to the component. The retainer is positioned within the central passage and is securely positioned between an interior surface of the sleeve and an outer surface of the fastener.

### RELATED APPLICATION

The present application claims priority to U.S. Provisional Patent Application No. 63/429,584, filed Dec. 2, 2022, and entitled “Captured Fastener for Thin Pads,” which is hereby incorporated by reference in its entirety.

### BACKGROUND

Automotive components require fastening techniques that are simple to manufacture and assemble. Further, fastening techniques should above all be reliable and efficient.

Automobile assemblies, for example, include various panels and structures connected to other panels or structures, or to the automobile frame itself. Fasteners (such as bolts) are typically used to secure various components together. In various applications, fasteners of different sizes, shapes, configurations and/or the like are used to secure components together.

In order to accommodate longer fasteners and/or fasteners at different positions, metal strips may be spot-welded or a metal spacer may be mechanically crimped to a flanged area of a component in order to thicken a clamped joint under a head of a bolt. As can be appreciated, the welding and/or crimping adds time and cost to a manufacturing process. Moreover, a specialized tool may be needed to secure the fastener to the components.

Therefore, despite advancements to date, it would be highly desirable to have a pre-captured fastener for thin components.

### SUMMARY

The present disclosure relates generally to a pre-captured fastener, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an isometric assembly view of a fastener-retaining system in accordance with an aspect of this disclosure.

FIGS. 1b and 1c illustrate, respectively, partially-assembled and fully-assembled isometric views of the fastener-retaining system.

FIG. 1d illustrates a side assembly view of the fastener-retaining system.

FIGS. 1e and 1f illustrate, respectively, partially assembled and fully assembled side views of the fastener-retaining system.

FIG. 1g illustrates a cross-sectional elevation view of the fastener-retaining system taken along cutline A-A (FIG. 1c).

FIG. 2a illustrates an isometric assembly view of the fastener-retaining system in accordance with an aspect of this disclosure.

FIG. 2b illustrates a side assembly view of the fastener-retaining system.

FIG. 2c illustrates a fully-assembled isometric view of the retainer assembly.

FIG. 2d illustrates a cross-sectional isometric view of the retainer assembly taken along cutline B-B (FIG. 2c).

FIG. 3 illustrates a cross-sectional side elevation view of a fastening system in accordance with another aspect of this disclosure.

FIG. 4 illustrates a side elevation assembly view of a fastening system in accordance with yet another aspect of this disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides various methods pre-capturing fasteners to thin components (e.g., thin panels, which can be thin metal, plastic, or composite panels or sheets) for easier fastening of the components. Variants include solutions for metal or plastic/composite panels and nut, bolt, or stud fasteners. The disclosed pre-captured fastener assembly offers a number of competitive advantages. For example, captured fastening offers several benefits such as increased assembly speeds. In addition, there are fewer inventory part numbers to manage and fewer part numbers to purchase. Further, quality improves because the risk of mixed, lost, and dropped loose parts is mitigated. Components with pre-captured fasteners also offer increased value and shipping costs are reduced.

The additional grip length afforded by the disclosed fastener-retaining system results in improved bolt stretch and clamp load characteristics. In some examples, a clip on solution can be ergonomically installed without automation required. Integrated compression-limiting helps to prevent damage to components due to clamp load and provides joint predictability. Finally, fastener retraction allows the component to be fully seated prior to tightening the fastener. This provides more reliable alignment and reduces cross-threading issues. The disclosed fastener assembly provides cost savings for a manufacturer because current known methods of obtaining added bolt stretch are achieved through spot welding large metal strips of thick material and/or mechanically crimping spacers to a flanged area of a component in order to thicken a clamped joint under a head of a bolt.

In one example, a retainer assembly that is configured to securely couple a fastener to a component having an opening comprises: a sleeve having a tube, a first flange, a second flange and a collar; and a retainer positioned within a central passage of the sleeve. The sleeve defines the central passage having a central longitudinal axis. The first flange and the second flange are separated by a tube. The collar is configured to reside within the opening and to provide compression limiting to the component. The retainer includes a first portion that securely connects to the sleeve, and a second portion that is configured to securely connect to a portion of the fastener.

In another example, a fastener assembly for use with a component having a first surface and a second surface opposite from the first surface, wherein an opening is formed through the component from the first surface to the second surface comprises: a fastener including a head connected to a shank; and a retainer assembly that securely couples the fastener to the component, the retainer assembly comprises: a sleeve having a tube, a first flange, a second flange and a collar; and a retainer positioned within a central passage of the sleeve. The sleeve defines the central passage having a central longitudinal axis. The first flange and the second flange are separated by a tube. The collar is configured to reside within the opening and to provide compression limiting to the component. The retainer includes a first portion that securely connects to the sleeve, and a second portion that is configured to securely connect to a portion of the fastener.

In yet another example, a retainer assembly that is configured to securely couple a fastener to a component comprises: a sleeve having a tube, a first flange, a second flange and a collar; wherein the sleeve defines a central passage having a central longitudinal axis, wherein the first flange and the second flange are separated by a tube, wherein the collar comprises one or more external ribbed features formed in or on an exterior surface of the collar and configured to press into and retain in the component, and wherein the collar is configured to reside within the opening and to provide compression limiting to the component; and a retainer positioned within the central passage, wherein the retainer is configured to be securely positioned between an interior surface of the sleeve and an outer surface of the fastener.

In some examples, the sleeve comprises one or more external ribbed features configured to press into and retain in the component.

In some examples, the one or more external ribbed features are formed in or on an exterior surface of the collar.

In some examples, the second portion includes one or more arcuately-shaped, inwardly-directed segments that bow toward a central longitudinal axis of the retainer and longitudinally extend along the retainer from a first edge to a second edge of the retainer such that the arcuately-shaped, inwardly-directed segments comprise the first edge and second edge.

In some examples, the one or more inwardly-directed segments are configured to abut an outer surface of the portion of the fastener.

In some examples, the retainer is configured to be securely positioned between an interior surface of the sleeve and an outer surface of the fastener.

In some examples, the retainer further comprises a retaining wall that includes the first portion and the second portion.

In some examples, the retaining wall has a clover shape.

In some examples, the first portion includes one or more outwardly-directed segments that directly abut into an interior surface of the sleeve, and wherein the second portion includes the one or more inwardly-directed segments that are configured to directly abut into an outer surface of the portion of the fastener.

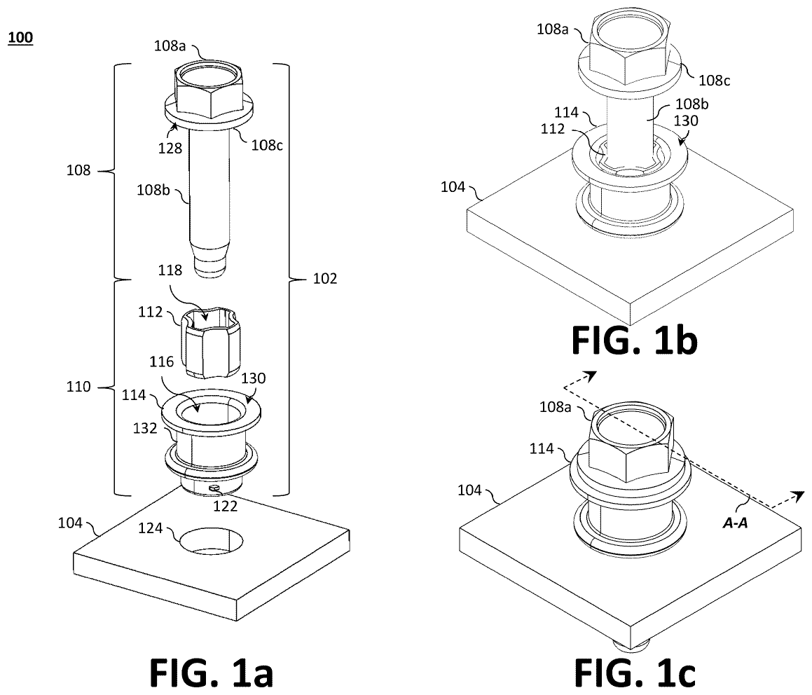

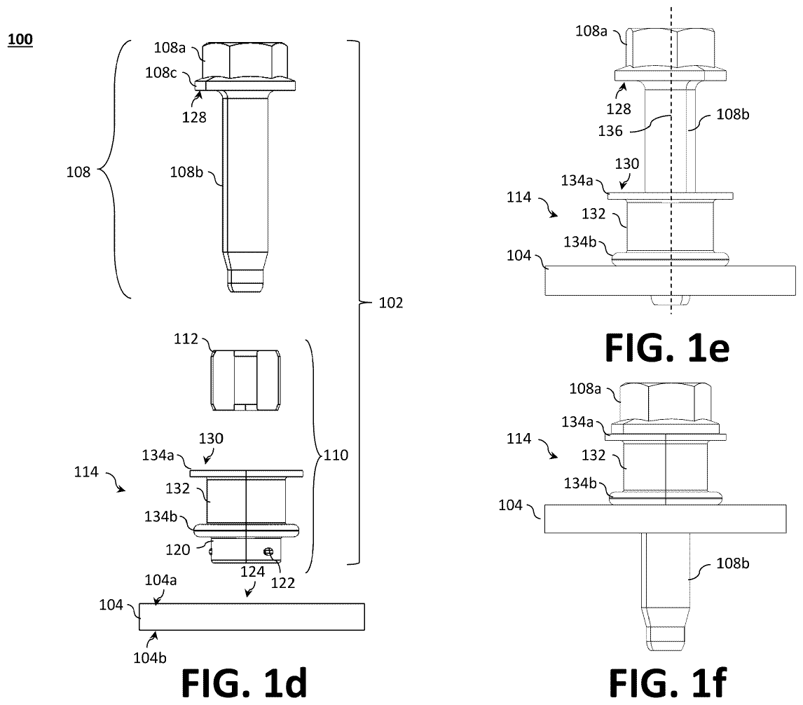

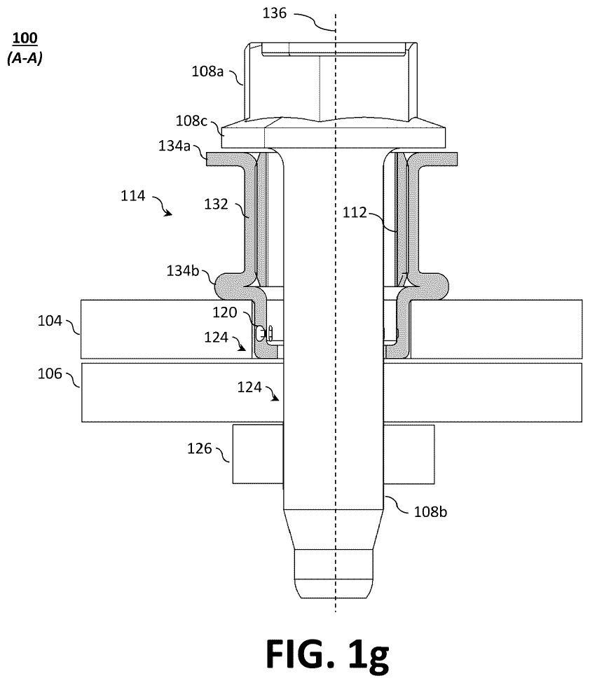

FIGS. 1a through 1d illustrate a fastener-retaining system 100 in accordance with an aspect of this disclosure having a fastener assembly 102 configured to couple a first component 104 relative to a second component 106 via a fastener 108 and a retainer assembly 110. The second component 106 is omitted from FIGS. 1a through 1d for illustrative purposes, but a non-limiting example is illustrated in FIG. 1g.

More specifically, FIG. 1a illustrates an isometric assembly view of the fastener-retaining system 100 in accordance with an aspect of this disclosure, while FIGS. 1b and 1c illustrate, respectively, partially-assembled and fully-assembled isometric views of the fastener-retaining system 100. FIG. 1d illustrates a side assembly view of the fastener-retaining system 100, while FIGS. 1e and 1f illustrate, respectively, partially assembled and fully assembled side views of the fastener-retaining system 100. FIG. 1g illustrates a cross-sectional elevation view of the fastener-retaining system 100 taken along cutline A-A (FIG. 1c).

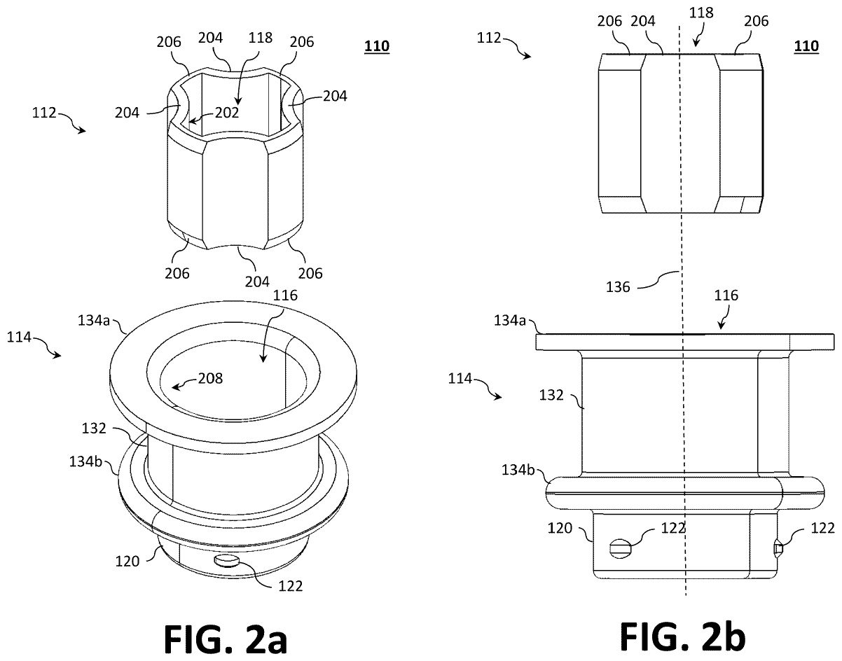

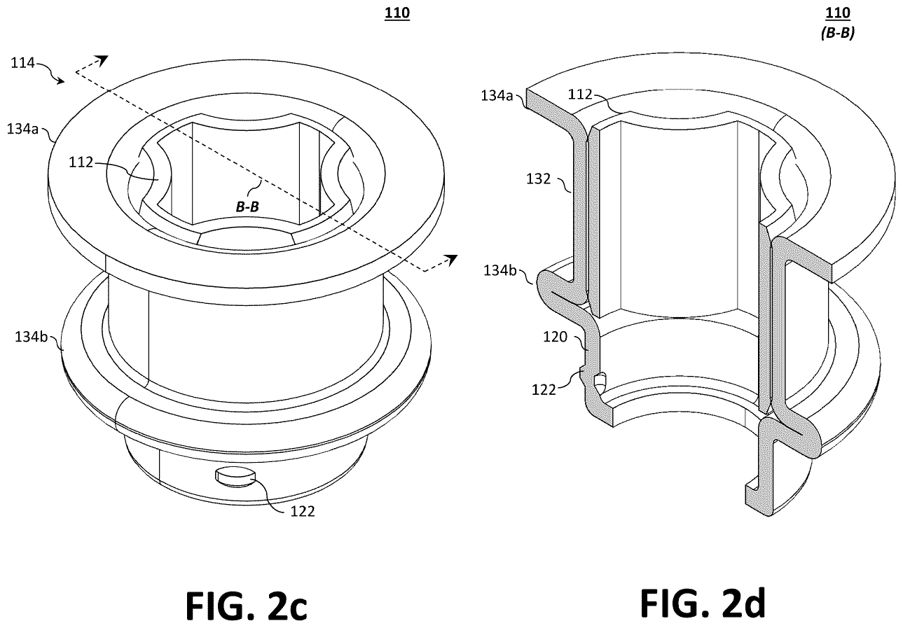

The illustrated fastener-retaining system 100 includes the first component 104, the second component 106, and the fastener assembly 102. The fastener assembly 102 is configured to join the first component 104 and the second component 106. In this example, the fastener assembly 102 generally comprises a fastener 108 and a retainer assembly 110. The retainer assembly 110 is illustrated as a multi-component retainer clip assembly having a retainer 112 and a sleeve 114. The retainer 112 is configured to be securely connected to and within an interior central passage 106 of the sleeve 114, while the fastener 108 resides within a central passage 118 of the retainer 112. The sleeve 114 is configured to be secured to the first component 104 via, for example, a collar 120 and/or one or more external ribbed features 122. The structure and features of the retainer assembly 110 will be discussed in greater detail in connection with FIGS. 2a through 2d.

The fastener assembly 102 can be used with, for example, the first component 104 in the form of a thin panel or sheet of metal having an opening 124 (or cutout) to receive the retainer assembly 110. The fastener assembly 102 provides a robust connection to the first component 104. The fastener 108 is pre-captured into the retainer assembly 110 a sleeve 114 utilizing a friction style retainer 112. In practice, the fastener assembly 102 can be provided as a pre-assembly that is then installed into a first component 104 for pre-capturing. The pre-assembled fastener assembly 102 solution enables fastener retraction, which allows the first component 104 to be placed flat onto a surface prior to the fastener 108 being tightened. The height of the sleeve 114 creates an increased amount of initial clamping force that does not need to utilize an additional spacer. The strength, robustness, and clamping force are due, at least in part, to an increased amount of fastened stretch, for example. The first component 104 generally benefits from the additional grip length afforded by the fastener assembly 102.

To facilitate attachment via the fastener assembly 102, each of the first component 104 and the second component 106 can include one or more engagement features. For example, the first component 104 and the second component 106 are each illustrated as having an opening 124 formed therein. An opening 124 can be formed in the first component 104 and/or the second component 106 during manufacturing thereof or added post-manufacture through a mechanical process (e.g., drilling, cutting, carving, etc.). The illustrated opening 124 extends between and through opposite surfaces 104a and 104b (such as a top surface and a bottom surface) of the first component 104. In some examples, the opening 124 can be threaded. For example, the opening 124 in the second component 106 can be threaded and configured to engage the fastener 108.

The fastener 108 is illustrated as a male fastener (e.g., a head 108a connected to a collar 108c with an externally-threaded shank 108b) configured to engage a female fastener (e.g., an internally-threaded component, such as a threaded collar, threaded opening, a nut 126, etc.). The fastener 108 may be a bolt, for example. At least a portion of the shank 108b be externally threaded. The shank 108b is coaxial with the head 108a and the collar 108c. In the illustrated example, the male fastener 108 is a threaded bolt with a hex-shaped head, but other types of fasteners and fastener heads are contemplated. The shank 108b of the fastener 108 passes through a central passage 118 of the retainer 112. As illustrated, when assembled, a lower surface 128 of the collar 108c abuts into an upper edge 130 of the tube 132 of the sleeve 114 (e.g., at the upper flange 134a). While a bolt is illustrated, a stud (or other similar component) can be used in lieu of the bolt.

The fastener 108 is configured to pass through the openings 124 and the retainer assembly 110 to mechanically engage and couple with the second component 106 and/or a nut 126. The male fastener 108 can be rotated relative to the nut 126 about its axis of rotation to join and compress the first component 104 and the second component 106 relative to one another. The sleeve 114 abuts into the surface 104a and is positioned over the opening 124 of the first component 104. The shank 108b extends through the central passage 118 and the opening(s) 124. The fastener-retaining system 100 securely connects the fastener 108 to the first component 104. When assembled, the sleeve 114 is compressively trapped between the upper surface 104a of the first component 104 and the portion of the fastener 108, such as the lower surface 128 of the collar 108c.

It is contemplated that certain components of the retainer assembly 110 may be fabricated from metal tubes and/or metal sheets via a metal-drawing, a metal-stamping, or other metal-forming technique. Certain other components of the retainer assembly 110 can be fabricated from a plastic material using a plastic injection technique, additive manufacturing, or otherwise. It is contemplated, however, that the retainer assembly 110 could also be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. In one example, the retainer 112 is formed of a plastic (e.g., a 3D-printed or injection-molded part) or other such material and configured to interact with a drawn metal compression-limiting sleeve 114.

The first component 104 and the second component 106 may be, for example, automotive panels or other automotive components. Depending on the application, one or both of the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 104 include, without limitation, door trim panels, moldings, trim pieces, and other substrates (whether used as interior or exterior surfaces). The second component 106 may be, for example, a frame, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

In some examples, the fastener assembly 102 may comprise a seal when desirable to mitigate dust, dirt, and/or moisture penetration through the opening(s) 124. The seal may be embodied as a ring (e.g., an annulus) and fabricated from foam material, thermoplastic, rubber, etc. For example, a seal can be configured to surround a portion of the male fastener 108 (e.g., the shank 108b) and positioned between the sleeve 114 and the first component 104 and/or between the head 108a and the sleeve 114.

After the first component 104 and the second component 106 are assembled, as best illustrated in FIG. 1g, the second component 106 can be covered at least partially by the first component 104. In some examples, one or both of the first component 104 and the second component 106 can include additional attachment features.

While FIG. 1g illustrates the fastener-retaining system 100 as being coupled to the second component 106 via a nut 126 such that the first component 104 and second component 106 abut one another, other fastening techniques and arrangements are contemplated. For example, rather than a threaded nut 126, a friction-based fastener can be used (e.g., a clip, sleeve, etc.). In another example, the opening 124 formed in the second component 106 can be threaded and configured to engage the fastener 108, thus obviating the need for additional fasteners (e.g., a nut 126). Further, it is also contemplated that the second component 106 could be positioned on the opposite side of the sleeve 114 (e.g., between the upper flange 134a and the head 108a).

FIGS. 2a through 2d illustrate enlarged views of an example retainer assembly 110. More specifically, FIG. 2a illustrates an isometric assembly view of the fastener-retaining system 100 in accordance with an aspect of this disclosure, while FIG. 2b illustrates a side assembly view thereof. FIG. 2c illustrates a fully-assembled isometric view of the retainer assembly 110, while FIG. 2d illustrates a cross-sectional isometric view of the retainer assembly 110 taken along cutline B-B (FIG. 2c). The illustrated retainer assembly 110 includes a compression-limiting sleeve 114 that engage and couples to a retainer 112.

The retainer assembly 110 is configured to securely retain the fastener 108 and securely connect the fastener 108 to the first component 104. The retainer assembly 110 provides an efficient, cost-effective system for accommodating fasteners at different heights and positions relative to the first component 104. The retainer assembly 110 captures the fastener 108 and couples the fastener 108 to the first component 104 without the need for separate tools. That is, an individual may couple the fastener-retaining system 100 to the fastener 108 and the first component 104 by hand.

The fastener-retaining system 100 includes the sleeve 114 and the retainer 112 within the interior central passage 116 defined by the sleeve 114. The retainer 112 includes a retaining wall 202 that surrounds a circumference of a portion of the shank 108b. The retaining wall 202 includes inwardly-directed segments 204 that abut into an outer surface of the shank 108b. The illustrated retainer 112 includes segmented or clover-shaped feature may be used to retain the fastener 108 inside the sleeve 114. The inwardly-directed segments 204 are arcuately-shaped and inwardly bow towards the central longitudinal axis 136. Interior surfaces of the inwardly-directed segments 204 may be threaded in order to threadably engage an outer threaded portion of the shank 108b of the fastener 108. The outwardly-directed segments 206 are outwardly bowed (such as in an opposite direction to the inward bowing of the inwardly-directed segments 204) in order to abut into interior surfaces 208 of the sleeve 114. The retaining wall 202 provides a main body that is configured to be positioned between the sleeve 114 and the shank 108b of the fastener 108.

The retaining wall 202 surrounds a circumference of a portion of the shank 108b. The retaining wall 202 includes outwardly-directed segments 206 integrally connected to inwardly-directed segments 204. An interior surface of the retaining wall 202 defines a central passage 118 into which the shank 108b of the fastener 108 passes. In at least one embodiment, interior surfaces of the inwardly-directed segments 204 are threaded and threadably engage exterior threaded portions of the shank 108b.

As shown, the retaining wall 202 includes four outwardly-directed segments 206 alternately connected to four inwardly-directed segments 204. Alternatively, the retaining wall 202 may include more or less segments 206 and 204 than shown. The outwardly-directed segments 206 abut into an interior surface of the sleeve 114, thereby securely bracing the retainer 112 into the sleeve 114. The inwardly-directed segments 204 abut into an outer surface of the shank 108b of the fastener 108. Portions of an outer surface, such as outwardly-directed segments 206, of the retainer 112 may abut into an interior surface 208 of the sleeve 114. In this manner, the sleeve 114 securely couples to the retainer 112. Further, the sleeve 114 is securely clamped between the head 108a of the fastener 108 and the upper surface 104a of the first component 104. The retainer 112 retains the shank 108b of the fastener 108 by way of the inwardly-directed segments 204 abutting into the shank 108b. The sleeve 114 secures around the retainer 112, such as by way of the outwardly-directed segments 206 abutting into interior surfaces 192 of the sleeve 114.

The sleeve 114 may be formed of a metal, and includes an annular tube 132 connected to one or more out-turned flanges 134a, 134b. The flanges 134a, 134b circumferentially extends from an upper end and a lower end of the tube 132. The tube 132 defines a central passage into which the retainer 112 is secured. As shown, the sleeve 114 includes two flanges 134a, 134b; one at each end of the tube 132. Optionally, the sleeve 114 may include a flange 134a, 134b at only one end. The sleeve 114 securely couples to the retainer 112 by way of the outwardly-directed segments 206 abutting into interior surfaces of the sleeve 114. The inwardly-directed segments 204 securely couple to the shank 108b of the fastener 108. The flange 134a of the sleeve 114 provides increased support surface area in relation to the lower surface 128 of the collar 108c. Similarly, the flange 134b provides increased support surface area in relation to the upper surface 104a of the first component 104. Alternatively, the sleeve 114 may not include the flange 134a and/or the flange 134b.

The sleeve 114 contains external ribbed features 122 for pressing into and retaining in a first component 104. The ribbed features 122 can be in the form of bumps, ridges, barbs, etc. The flange 134b holds the first component 104 tightly when fastened. The sleeve 114 has additional height above the first component 104 for added fastener grip length, which improves joint performance. The sleeve 114 includes a collar 120 under the intermediate flange 134b to provide compression limiting to the first component 104, thus preventing it from being crushed by the fastener 108 load. The height of the collar 120 generally correspond to the thickness of the first component 104 and the diameter of the collar 120 corresponds to the diameter of the opening 124 formed in the first component 104.

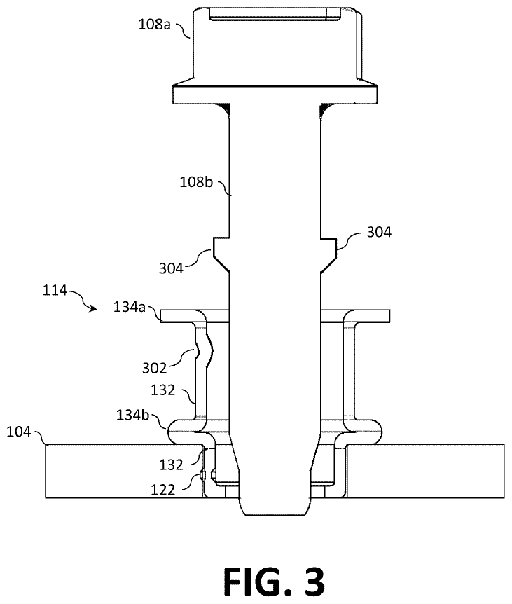

FIG. 3 illustrates a cross-sectional side elevation view of a fastening system in accordance with another aspect of this disclosure. The fastener assembly 102 of FIG. 3 is similar to the fastener assembly 102 of FIGS. 1a through 1g and 2a through 2d, except the fastener 108 is pre-captured relative to the sleeve 114 via internal nibs 302 in the sleeve 114 snapping through an interference fit with the annular ring 304 formed on the shank 108b of the fastener 108. As illustrated, the annular ring 304 engages the internal nibs 302 to mitigate risk of pullout. In this example, the retainer 112 is omitted in favor of the annular ring 304 and the internal nibs 302.

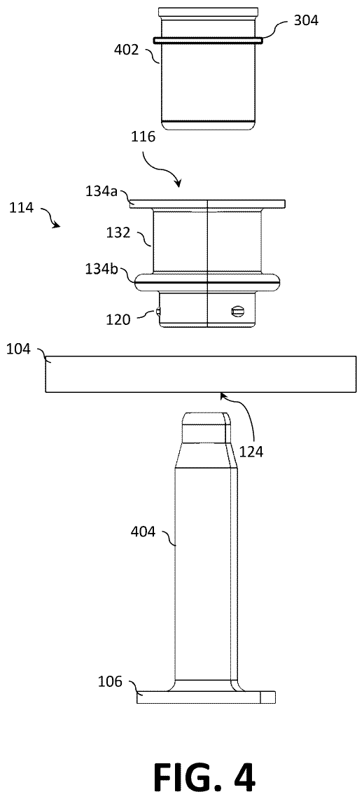

FIG. 4 illustrates a side elevation assembly view of a fastening system in accordance with yet another aspect of this disclosure. The fastener assembly 102 of FIG. 3 is similar to the fastener assembly 102 of FIGS. 1a through 1g and 2a through 2d, except that a retainer nut 402 is used instead of the fastener 108. The retainer nut 402 is designed to screw onto a fixed, externally threaded stud 404 by rotating the hex retainer nut 402, which is internally threaded. This design allows for the retainer nut 402 to telescope inside of the sleeve 114. This reduces overall height of the design and allows the retainer nut 402 to fully retract. In this example, the retainer 112 is omitted. In some examples, the retainer nut 402 can be retained within the 116 via an annular ring 304 and internal nibs 302 (not visible in FIG. 4).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A retainer assembly that is configured to securely couple a fastener to a component having an opening, the retainer assembly comprising:
a sleeve having a tube, a first flange, a second flange and a collar,
wherein the sleeve defines a central passage having a central longitudinal axis,
wherein the first flange and the second flange are separated by a tube, and
wherein the collar is configured to reside within the opening and to provide compression limiting to the component; and
a retainer positioned within the central passage,
wherein the retainer includes a first portion that securely connects to the sleeve, and a second portion that is configured to securely connect to a portion of the fastener.

2. The retainer assembly of claim 1, wherein the sleeve comprises one or more external ribbed features configured to press into and retain in the component.

3. The retainer assembly of claim 2, wherein the one or more external ribbed features are formed in or on an exterior surface of the collar.

4. The retainer assembly of claim 1, wherein the second portion includes one or more arcuately-shaped, inwardly-directed segments that bow toward a central longitudinal axis of the retainer and longitudinally extend along the retainer from a first edge to a second edge of the retainer such that the arcuately-shaped, inwardly-directed segments comprise the first edge and second edge.

5. The retainer assembly of claim 4, wherein the one or more inwardly-directed segments are configured to abut an outer surface of the portion of the fastener.

6. The retainer assembly of claim 1, wherein the retainer is configured to be securely positioned between an interior surface of the sleeve and an outer surface of the fastener.

7. The retainer assembly of claim 1, wherein the retainer further comprises a retaining wall that includes the first portion and the second portion.

8. The retainer assembly of claim 7, wherein the retaining wall has a clover shape.

9. The retainer assembly of claim 1, wherein the first portion includes one or more outwardly-directed segments that directly abut into an interior surface of the sleeve, and wherein the second portion includes the one or more inwardly-directed segments that are configured to directly abut into an outer surface of the portion of the fastener.

10. A fastener assembly for use with a component having a first surface and a second surface opposite from the first surface, wherein an opening is formed through the component from the first surface to the second surface, the fastener assembly comprising:
a fastener including a head connected to a shank; and
a retainer assembly that securely couples the fastener to the component, the retainer assembly comprising:
a sleeve having a tube, a first flange, a second flange and a collar,
wherein the sleeve defines a central passage having a central longitudinal axis,
wherein the first flange and the second flange are separated by a tube, and
wherein the collar is configured to reside within the opening and to provide compression limiting to the component; and
a retainer positioned within the central passage,
wherein the retainer includes a first portion that securely connects to the sleeve, and a second portion that is configured to securely connect to a portion of the fastener.

11. The fastener assembly of claim 10, wherein the sleeve comprises one or more external ribbed features configured to press into and retain in the component.

12. The fastener assembly of claim 11, wherein the one or more external ribbed features are formed in or on an exterior surface of the collar.

13. The fastener assembly of claim 10, wherein the second portion includes one or more arcuately-shaped, inwardly-directed segments that bow toward a central longitudinal axis of the retainer and longitudinally extend along the retainer from a first edge to a second edge of the retainer such that the arcuately-shaped, inwardly-directed segments comprise the first edge and second edge.

14. The fastener assembly of claim 13, wherein the one or more inwardly-directed segments are configured to abut an outer surface of the portion of the fastener.

15. The fastener assembly of claim 10, wherein the retainer is configured to be securely positioned between an interior surface of the sleeve and an outer surface of the fastener.

16. The fastener assembly of claim 10, wherein the retainer further comprises a retaining wall that includes the first portion and the second portion.

17. The fastener assembly of claim 16, wherein the retaining wall has a clover shape.

18. The fastener assembly of claim 10, wherein the first portion includes one or more outwardly-directed segments that directly abut into an interior surface of the sleeve, and wherein the second portion includes the one or more inwardly-directed segments that are configured to directly abut into an outer surface of the portion of the fastener.

19. A retainer assembly that is configured to securely couple a fastener to a component, the retainer assembly comprising:
a sleeve having a tube, a first flange, a second flange and a collar;
wherein the sleeve defines a central passage having a central longitudinal axis,
wherein the first flange and the second flange are separated by a tube,
wherein the collar comprises one or more external ribbed features formed in or on an exterior surface of the collar and configured to press into and retain in the component, and
wherein the collar is configured to reside within the opening and to provide compression limiting to the component; and
a retainer positioned within the central passage, wherein the retainer is configured to be securely positioned between an interior surface of the sleeve and an outer surface of the fastener.

20. The retainer assembly of claim 19, wherein the retainer includes a clover-shaped retaining wall that defines a central longitudinal axis and includes a plurality of outwardly-directed segments that directly abut into an interior surface of the sleeve to securely couple the retainer to the sleeve, and a plurality of inwardly-directed segments that are configured to directly abut into an outer surface of a shank of the fastener to securely connect the sleeve to the fastener, wherein each of the inwardly-directed segments bow toward the central longitudinal axis, and wherein each of the inwardly-directed segments alternate with each of the outwardly-directed segments.
